(19) United States
(12) Patent Application Publication
(10) Pub. No.: US 2008/0215589 A1
(43) Pub. Date: Sep. 4, 2008

(54) System, Method, and Computer-Readable Medium for Collection and Distribution of User-Supplied Comments Associated with Network and Local Content

(75) Inventor: Eran ELHAIK, Houston, TX (US)

Correspondence Address: HAYNES AND BOONE, LLP, 901 Main Street, Suite 3100, Dallas, TX, 75202, US

(73) Assignee: GETINGATE, INC., Houston, TX (US)

(21) Appl. No.: 11/770,638

(22) Filed: Jun. 28, 2007

Related U.S. Application Data
(60) Provisional application No. 60/884,769, filed on Jan. 12, 2007.
(60) Provisional application No. 60/865,355, filed on Nov. 10, 2006.

(51) Int. Cl. G06F 17/30

(52) U.S. Cl. 707/10; 707/E17.032

(57) ABSTRACT

A system, method and computer-readable medium for collection and distribution of user-supplied comments associated with network and local content is provided. User-supplied comments may be associated with network content and may be stored in a network repository in association with an identifier of the network content for which the comments were supplied. Other network users that view the content may be provided with the user-supplied comments associated with the content. User-supplied comments associated with local content may be stored in a local repository. Comments associated with local content may be displayed to a user in response to selection of the local content.

### RELATED APPLICATION DATA

This patent application claims the benefit of provisional U.S. Patent Application Ser. No. 60/865,355, filed Nov. 10, 2006, entitled “SYSTEM AND METHOD FOR A COMMENTS BAR IN A WEB BROWSER,” which is hereby incorporated by reference, and provisional U.S. Patent Application Ser. No. 60/884,769, filed Jan. 12, 2007, entitled “SYSTEM AND METHOD FOR A NEUROX BAR FOR WINDOWS FILE SYSTEM—A COMMENTS BAR IN A WEB BROWSER, A COMMENTS BAR IN A WINDOW BROWSER, AND A WEB CLIENT PROGRAM,” which is hereby incorporated by reference.

### BACKGROUND

Various toolbars are widely used in data processing and networking environments. Toolbars are typically statically implemented, that is the toolbar offers several links and there is no information flow from the user to the toolbar or from the toolbar to the user. Some toolbars offer a search option to a particular database or for a web query engine. The query results may be shown in a new browser window.

In a client-server network adapted to provide content, such as hypertext markup language (HTML) pages to clients, many clients may access common content. To facilitate discussion of page content among users, a comments section may be included in the web page source code, or otherwise logically associated therewith at the web page server, that allows users to enter comments. The provisioning of comment collection and posting with a web page at a web server is referred to herein as a feedback comment system. Upon entry of the user comment, the comment may be posted to the web page, e.g., appended to the page, and is subsequently viewable by other users. Users may be additionally allowed to reply to specific comments thereby enhancing the overall community aesthetic and experience provided by the page.

### BRIEF DESCRIPTION OF THE DRAWINGS

Aspects of the present disclosure are best understood from the following detailed description when read with the accompanying figures, in which:

FIG. 1 is a diagrammatic representation of a network system of data processing systems in which embodiments may be implemented;

FIG. 2 is a diagrammatic representation of an exemplary comments server that may be configured for storage and distribution of user comments in accordance with embodiments disclosed herein;

FIG. 3 is a diagrammatic representation of an exemplary client system depicted in FIG. 1 in which embodiments disclosed herein may be implemented;

FIG. 4 is a diagrammatic representation of an embodiment of a software configuration that facilitates user supply and network distribution of comments associated with web pages or system files or other data structures;

FIG. 5 depicts a diagrammatic representation of a table that may be implemented in a comments repository for storing user-supplied web page comments in accordance with embodiments disclosed herein;

FIG. 6A is a diagrammatic representation of a comments bar application user interface implemented in accordance with an embodiment;

FIG. 6B is a diagrammatic representation of a comments bar configured in an expanded view in accordance with an embodiment;

FIG. 6C is a diagrammatic representation of a comments bar configured in an expanded view as may be displayed in conjunction with a browser window display of a web page on a display device in accordance with an embodiment;

FIG. 6D is a diagrammatic representation of a comments entry interface that may be displayed within a comments bar in accordance with an embodiment;

FIG. 6E is a diagrammatic representation of another embodiment of a comments entry interface of a comments bar implemented in accordance with an embodiment;

FIG. 7 is a flowchart depicting a client-side comment bar processing routine that may be implemented in accordance with an embodiment;

FIG. 8 is a flowchart depicting a client-side comment bar processing routine for displaying user comments made in association with a web page that may be implemented in accordance with an embodiment;

FIG. 9 is a flowchart of a client-side comment application processing routine that facilitates expansion and collapse of a comments bar in accordance with an embodiment;

FIG. 10 is a diagrammatic representation of a table that may be implemented in a local repository for storing user-supplied comments associated with local files, directories, or other data structures in accordance with embodiments disclosed herein;

FIG. 11 is a diagrammatic representation of a comments bar implemented in accordance with an embodiment that facilitates collection of user-supplied comments related to local data structures and display of the comments;

FIG. 12 is a diagrammatic representation of a comments bar interface that facilitates display and manipulation of comments in accordance with an embodiment;

FIG. 13 is a diagrammatic representation of another comments bar interface that facilitates community interaction among users in accordance with an embodiment;

FIG. 14 is a flowchart depicting client-side processing of a comments bar routine for collecting data structure comments in accordance with an embodiment; and

FIG. 15 is a flowchart depicting client-side processing of a comments bar routine for displaying comments associated with data structures in accordance with an embodiment.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Heretofore, no system has been provided that allows for comment submission and posting of comments to web pages that do not feature a feedback comment system. In accordance with embodiments disclosed herein, a system, method, and computer-readable medium are provided that allow for user submission of comments in association with web pages or other data structures regardless of whether the page or data structure includes or is associated with a feedback comment system. In other embodiments, the user-supplied comments may be stored in a repository and distributed to other client systems in response to a client system visiting a page to which a user-comment has been archived in the repository. In particular, user supplied comments are made on a per URL or domain (or other address reference) basis and are uniquely associated with the URL or domain and are not limited to any file type or content maintained at the associated address. In a similar manner, comments may be supplied that are associated with a local file address, rather than a URL or domain.

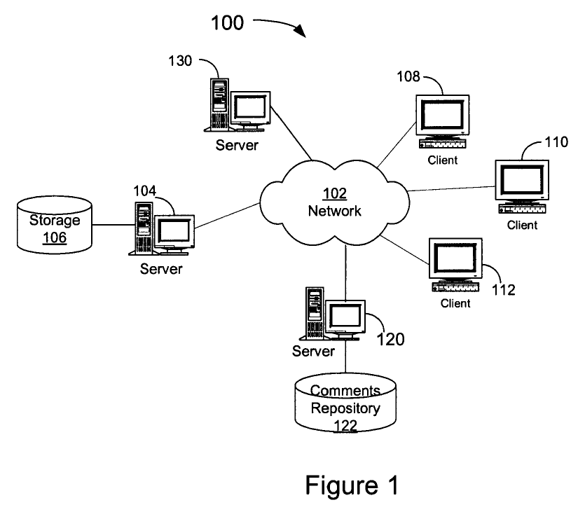

With reference now to the figures, FIG. 1 is a diagrammatic representation of a network system 100 of data processing systems in which embodiments may be implemented. Network system 100 may comprise a network of computers in which one or more embodiments disclosed herein may be implemented. Network system 100 may include a network 102 which provides communications links between various devices and computers connected together within network system 100. Network 102 may include connections, such as wire, wireless communication links, or fiber optic cables, and various network infrastructure, such as routers, switches, bridges, to facilitate communications among various network-connected devices.

In the depicted example, a server 104 is connected to network 102 along with a storage unit 106. In addition, clients 108-112 are connected to network 102. Server 104 may comprise, for example, a Hypertext Transfer Protocol (HTTP) server, and may include or interface with a storage device 106 in which web pages are stored and retrieved for transmission to clients. It is understood that pages may be stored statically in storage 106, may be generated dynamically, and may include various media content, such as images, and video, in addition to page text. Clients 108-112 may be, for example, personal computers, laptops, personal digital assistants, or other network-connected computers or data processing systems.

In accordance with an embodiment, system 100 may include a comments server 120 adapted to store user comments provided thereto in a repository 122 and distribute user comments to clients therefrom as described more fully hereinbelow. In general, repository 122 may comprise a database, and thus comments server 120 may include, or interface with, a database management system.

Network system 100 may include additional servers, clients, and other devices not shown. In the depicted example, network system 100 may comprises the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, comprising thousands of commercial, government, educational and other computer systems that route data and messages. Of course, network system 100 also may be implemented as a number of different types of networks, such as, for example, an intranet, a local area network (LAN), or a wide area network (WAN). FIG. 1 is intended as an example, and not as an architectural limitation, of a network system in which embodiments disclosed herein may be implemented.

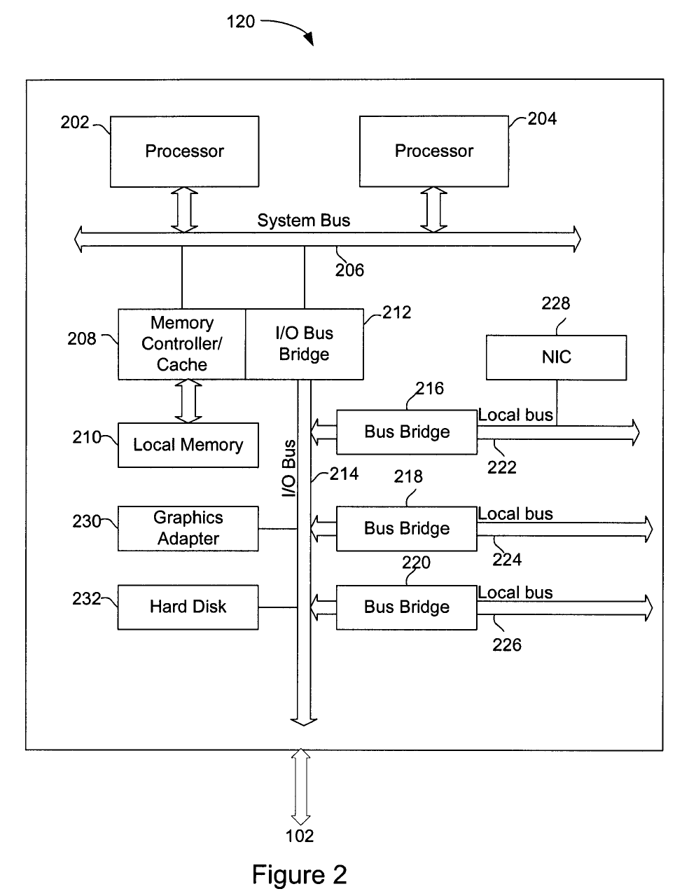

FIG. 2 is a diagrammatic representation of an exemplary comments server 120 that may be configured for storage and distribution of user comments in accordance with embodiments disclosed herein.

Server 120 may be a symmetric multiprocessor (SMP) system that includes a plurality of processors 202 and 204 connected to a system bus 206 although other single-processor or multi-processor configurations may be suitably substituted therefor. A memory controller/cache 208 that provides an interface to a local memory 210 may also be connected with system bus 206. An I/O bus bridge 212 may connect with system bus 206 and provide an interface to an I/O bus 214. Memory controller/cache 208 and I/O bus bridge 212 may be integrated into a common component.

A bus bridge 216, such as a Peripheral Component Interconnect (PCI) bus bridge, may connect with I/O bus 214 and provide an interface to a local bus 222, such as a PCI local bus. Communication links to other network nodes of system 100 in FIG. 1 may be provided through a network interface card (NIC) 228 connected to local bus 222 through add-in connectors. Additional bus bridges 218 and 220 may provide interfaces for additional local buses 224 and 226 from which peripheral or expansion devices may be supported. A graphics adapter 230 and hard disk 232 may also be connected to 1/0 bus 214 as depicted. HTTP server 104 may be configured similar to server 120 or may alternatively be implemented in any number of server configurations.

Those of ordinary skill in the art will appreciate that the hardware depicted in FIG. 2 may vary. The depicted example is not intended to imply architectural limitations with respect to implementations of the present disclosure.

In accordance with embodiments disclosed herein, comments server 120 may include computer-executable instructions tangibly embodied on a computer-readable medium, such as local memory 210 or hard disk 232, that are run in conjunction with an operating system, such as a Unix operating system implemented as computer executable instructions executed by an instruction execution device, such as one or more of processors 202 and 204. Comments server 120 may feature or otherwise interface with a database management system that facilitates storage, retrieval, and manipulation of comments stored in a database implemented in repository 122.

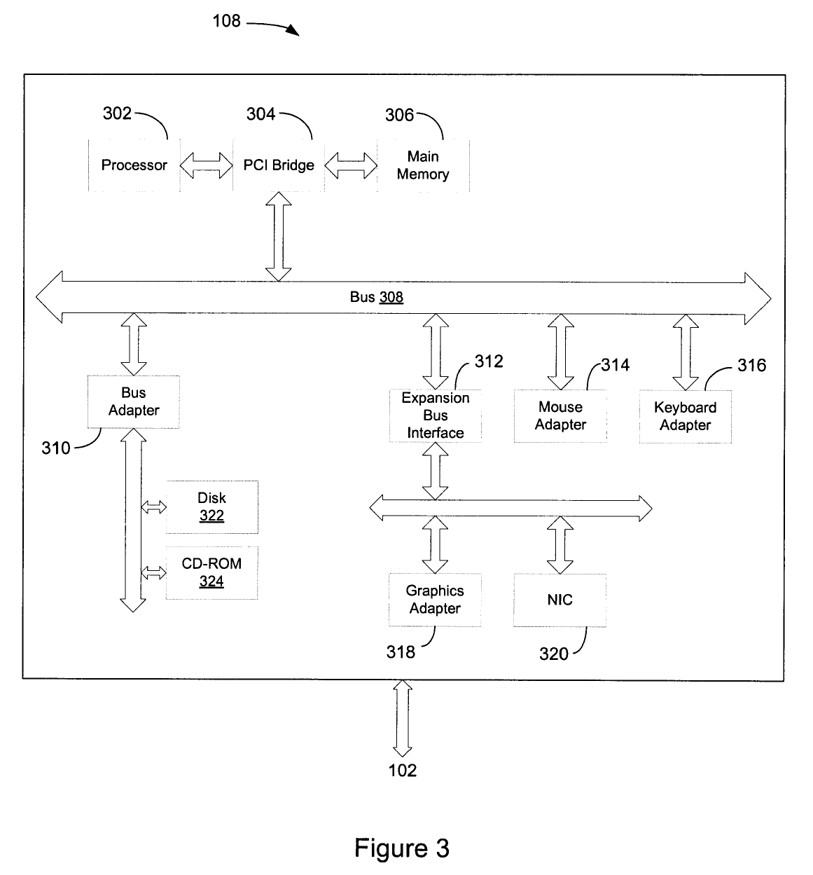

FIG. 3 is a diagrammatic representation of an exemplary client system, such as client 108, depicted in FIG. 1 in which embodiments disclosed herein may be implemented.

Code or instructions implementing client processes of embodiments disclosed herein may be located or accessed by client 108. In the illustrative example, client 108 employs a PCI local bus architecture, although other bus architectures, such as the Industry Standard Architecture (ISA), may be used. A processor system 302 and a main memory 306 are connected to a PCI local bus 308 through a PCI bridge 304. PCI bridge 304 also may include an integrated memory controller and cache memory for a processor 302. Additional connections to PCI local bus 308 may be made through direct component interconnection or through add-in connectors. In the depicted example, a small computer system interface (SCSI) host bus adapter 310, an expansion bus interface 312, a mouse adapter 314, and a keyboard adapter 316 are connected to PCI local bus 308 by direct component connection. In contrast, a graphics adapter 318 and a NIC 320 are connected to PCI local bus 308 via expansion bus interface 312 by add-in boards inserted into expansion slots. NIC 320 provides an interface for connecting console 112 with other devices in system 100 depicted in FIG. 1. Expansion bus interface 312 provides a connection for various peripheral devices. SCSI host bus adapter 310 provides a connection for a hard disk drive 322, and a CD-ROM drive 324. Typical PCI local bus implementations may support a plurality of PCI expansion slots or add-in connectors.

An operating system runs on processor 302 and is used to coordinate and provide control of various components within client 108. Instructions for the operating system and applications or programs are located on storage devices, such as hard disk drive 322, and may be loaded into main memory 306 for execution by processor 302.

Those of ordinary skill in the art will appreciate that the hardware depicted in FIG. 2 is exemplary only and is provided to facilitate an understanding of disclosed embodiments, and the depicted example is not intended to imply architectural limitations with respect to implementations of the present disclosure. Rather, any variety data processing or computational devices may be deployed as a client adapted to implement embodiments disclosed herein. For example, a client may comprise a cell phone, a personal digital assistant, pocket PC, a terminal, or any other suitable data processing system that provides or otherwise facilitates Internet access. In still other embodiments, a data processing system may be adapted to implement embodiments disclosed herein without providing for Internet access as described more fully hereinbelow.

In accordance with embodiments disclosed herein, client 108 may include computer-executable instructions tangibly embodied on a computer-readable medium, such as memory 306 or hard disk 322, that are run in conjunction with an operating system, such as a Windows operating system implemented as computer executable instructions executed by an instruction execution device, such as processors 302. Computer-executable instructions may include executable logic that facilitates collection of user-supplied comments that may be associated with a web page, and logic that facilitates transmission of the user-supplied comments to comments server 120. Furthermore, computer-executable instructions run by client 108 may include logic that facilitates interrogation of comments server 120 for retrieving user-supplied comments therefrom for display in association with a web page that is displayed by a browser. In other embodiments, computer-executable instructions run by client 108 may include logic that facilitates collection of user-supplied comments that are associated with local files or other data structures, storage of the user-supplied comments in a local repository, retrieval of the user-supplied comments from the local repository, and display of the user-supplied comments in association with a local file, directory, or other data structure with which the displayed comment is associated. These, and other embodiments, will become readily apparent as disclosed more fully hereinbelow.

As discussed above, a client system, such as one of clients 108-112, may connect with server 104 and receive a web page therefrom. The web page may be processed by a browser or other suitable application for display thereby. In accordance with an embodiment, the client may run a comments bar application that displays a comments bar adapted to receive user-supplied comments. In this manner, the user may comment on a web page displayed by a browser. Upon entry of a comment, the user may select an appropriate control, and the comments bar application may transmit the comment to comments server 120 where it is stored in repository 122. In one implementation, the comments bar application may read or otherwise retrieve the URL or domain of the web page currently displayed by the browser when the user selects the control designating that the comment is complete. As referred to herein, a URL may refer to either a uniform resource locator or a domain. Accordingly, the comments bar application may encapsulate the web page URL and the comment in one or more packets comprising a comment message that are transmitted to comments server 120. In this manner, the comment and the web page are mutually associated with one another. Additionally, the comment message may optionally include a user ID and/or a timestamp that indicates the time at which the comment was supplied by the user.

In another embodiment, comment submissions by clients and retrieval of comments for display may be facilitated via a proxy server 130. In this manner, a client need not be equipped with the comments bar application. Rather, a client may connect with proxy server 130 and submit a URL of a web page thereto. Proxy server 130 may, in turn, retrieve the web page and query comments repository 122. Any comments associated with the web page may then be processed for display with the web page. The web page and associated comments may then be transmitted to the client. In a similar manner, a comments bar may be transmitted to a client connected with proxy server 130, e.g., as JavaScript or other suitable software. In this manner, the client may submit and view comments of a web page received by proxy without requiring the comments bar application to have been installed at the client.

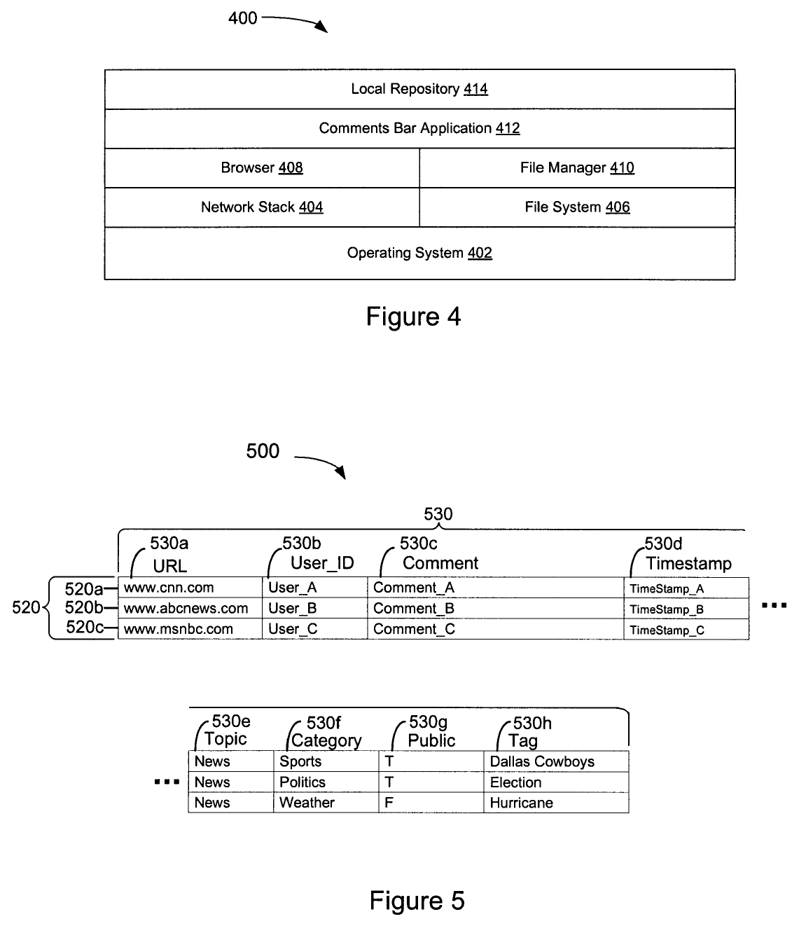

FIG. 4 is a diagrammatic representation of an embodiment of a software configuration 400 that facilitates user supply and network distribution of comments associated with web pages or system files or other data structures. Configuration 400 includes an operating system 402, such as any one of various Windows operating systems manufactured by Microsoft Corporation of Redmond, Wash., that manages execution of a network stack 404 that provides for network communications. For example, network stack 404 may be implemented as a transmission control protocol/Internet protocol (TCP/IP) stack. Configuration 400 may include a file system 406, such as a file allocation table-based file system, or any other suitable file system that facilitates file organization and access of system files. A browser 408, such as Internet Explorer, Netscape Navigator, or any other suitable web browser, adapted to display and interact with web page content and/or other network content, may interface with an application layer of network stack 404. Additionally, software configuration 400 may include a file manager 410, such as Windows Explorer manufactured by Microsoft Corporation of Redmond, Wash., Macintosh Finder manufactured by Apple Computer, Inc. of Cupertino, Calif., or another file management system adapted to interact or manipulate file system 408.

A comments bar application 412 may be deployed in configuration 400 and may comprise a computer program implemented as computer-executable instruction sets that may be executed by a processing device, such as processor 302 depicted in FIG. 3. In accordance with an embodiment, comments bar application 412 may interface with both browser 408 and file manager 410. Additionally, configuration 400 may include a local comments repository 414 that may be interfaced by comments bar application 412. In an alternative embodiment, the comments bar functionality may be implemented within the browser code. The comments bar may alternatively be implemented as an add-on to a directory tool or file manager, may be implemented as a tool bar or application, a browser plug-in, or any other suitable software configuration.

In accordance with an embodiment, comments bar application 412 may be displayed in association with browser 408. For example, comments bar application 412 may be implemented with a listener or other routine that monitors browser 408 for particular events. In a particular implementation, comments bar application 412 may be configured to monitor browser 408 for instantiation upon which comments bar application 412 is activated. Additionally, comments bar application 412 may be configured to be minimized when a minimization event of browser 408 is detected. Likewise, comments bar application 412 may be configured to be maximized when a maximization event of browser 408 is detected. In this manner, comments bar application 412 may be brought to the display foreground in conjunction with a foreground display of browser 408. Comments bar application 412 preferably includes a comments entry field that allows entry of user comments therein. A user may select a control upon completion of entry of a comment. Selection of the completion control may be signaled to a comment repository message subroutine of comments bar application 412 that, in response thereto, generates a comment message including the user-entered comment as well as the URL of a page that is displayed by browser 408 at the time of user-selection of the completion control. Additionally, the repository message may include a user ID of the user that has entered the comment and may additionally include a timestamp, e.g., a time at which the completion control was selected by the user. Comments bar application 412 may then transmit the comment message via network stack 404 to comments server 120 for storage of the comment and page URL, and optionally the user ID and timestamp, in comments repository 122.

Additionally, comments bar application 412 may be adapted to receive comments from comments server 120 and display the comments in association with a web page displayed by browser 408. In accordance with an embodiment, when a web page is loaded and displayed by browser 408, comments bar application 412 is adapted to retrieve or otherwise obtain the page URL and query comments server 120 with the page URL. Comments server 120, in turn, may interrogate comments repository 122 with the URL and return comments stored therein that are associated with the URL. Comments bar application 412 may then display the received comments in the comments bar application display panel. When the user navigates to another web page, the comments bar application may again query comments server 120 with the URL of the web page to which the user has navigated and display any received comments associated with the URL of the newly navigated web page.

In accordance with another embodiment, comments bar application may interface with file manager 410 and receive user-supplied comments associated with a file, directory, or other data structure. User-supplied comments may then be associated with the file, directory, or other data structure and stored in a local repository. Comments may be retrieved from the repository and displayed in association with the file or other data structure, for instance when a user is browsing a file management directory. Additionally, comments may be indexed with a user ID to allow storage and display of comments provided by multiple users on a system which is accessed by multiple users.

FIG. 5 depicts a diagrammatic representation of a table 500 comprising a plurality of records 520a-520c (collectively referred to as records 520) and fields 530a-530h (collectively referred to as fields 530) that may be implemented in comments repository 122 for storing user-supplied web page comments in accordance with embodiments disclosed herein. Table 500 may be stored on a disk drive or other suitable medium, fetched therefrom by a processor or other instruction processing device, and processed by a data processing system such as comments server 120 depicted in FIG. 1.

Fields 530 have a respective label, or identifier, that facilitates insertion, deletion, querying, or other data operations or manipulations of table 500. In the illustrative example, fields 530a-530h have respective labels of URL, User_ID, Comment, TimeStamp, Topic, Category, Public, and Tag. Each record 520a-520c records a user-supplied comment in association with a URL or domain or other content address reference for which the associated comment was supplied.

Data elements stored in URL field 530a may comprise a web page URL or other uniform resource identifier (URI) that specifies the location of a web page. In the illustrative example, data elements stored in URL field 530a of records 520a-520c comprise URLs of “www.cnn.com”, “www.abcnews.com”, and “www.msnbc.com”. User_ID field 530b may maintain data elements, such as user names or tags, assigned to a user that has supplied a comment associated with the web page specified by URL field 530a of a corresponding record 520. In the illustrative example, data elements stored in User_ID field 530b of respective records 520a-520c comprise user IDs of “User_A”, “User_B”, and “User_C”. Comment field 530c may maintain data elements, e.g., string-type data elements, comprising a user-supplied comment provided in association with a web page specified by URL field 530a of a corresponding record 520. In the illustrative example, comments maintained in Comment field 530c of respective records 520a-520c are illustratively designated “Comment_A”-“Comment_C” and are representative of comment strings supplied by a user in association with a web page. It is understood that comments supplied by a user and stored in Comment field 530c may comprise alphabetic, numeric, alphanumeric, hyperlink text, flash, video, music files as well as other graphic characters that may be supplied by a user by an input device such as a keyboard and may comprise multiple input lines of data. TimeStamp field 530d may maintain a timestamp value that indicates the time at which the comment maintained in comment field 530c of a corresponding record was supplied by the user. Data elements stored in TimeStamp field 530d of respective records 520a-520c are illustratively designated “TimeStamp_A”-“TimeStamp_C” and are representative of a time code specifying a time at which a comment recorded in Comment field 530c was supplied by a user. The timestamp may specify a day, date, and/or time at which a corresponding comment was supplied by a user. Topic field 530e may store user supplied or selected topics relating to the information content of the URL or domain for which the corresponding comment is associated. In the present example, the topic fields 530e of records 520a-520c store data elements of “News”. The category field 530f may store user supplied or selected category associated with the URL or domain of the corresponding comment. In the present example, category field 530f of records 520a-520c have date elements of “Sports”, “Politics”, and “Weather”. Public field 530g may maintain date elements that specify whether a corresponding comment is to be public or private. For example, public comments may be viewed by any user navigating to a URL or domain for which a public comment has been provided. A private comment may be available only the user that supplied the comment. In other embodiments, a private comment may be group based. In this instance, the group based private comment may be available only to users of a particular group, e.g., a chat group or any other collection of users. In the present example, public field 530g has value of true (“T”) in records 520a-520b and a value of false (“F”) in record 520c thereby indicating that the comments of records 520a-520b are public and the comment of record 520c is private. Tag field 530h may store user supplied tags to be associated with a corresponding comment. In the present example, tag field 530h has tags of “Dallas Cowboys”, “Election” and “Hurricane” in respective records 520a-520c. Numerous tag fields may be included in table 500. For example, various public and/or private tag fields may be included in addition to tag field 530h. Other information may be maintained in table 500 or in association therewith, such as information collected from the website (e.g., page tags, domain name, etc.) and the user (e.g., the user IP address, MAC address, etc.) traffic information, statistical information, or other suitable information.

In operation, when a user supplies a comment to a client comment bar application, the comment and page URL are transmitted to comment server 120 which, in turn, inserts a record into table 500. Comment server, or a database management system acting on behalf thereof, then writes the URL to URL field 530a of the newly inserted record and writes the user supplied comment into field 530c of the same record. Additionally, a user ID and timestamp may optionally be written to respective User_ID field 530b and TimeStamp field 530d. In an alternative embodiment, the comments and associated information may be stored locally at the client.

When a client running an instance of a comment bar application implemented in accordance with embodiments disclosed herein navigates to a web page, the client's comment bar application may read or otherwise obtain the web page URL, and query comments server 120 with the URL. Comments server 120, in turn, may interrogate repository 122 with the URL. The comments of any records of table 500 having a matching URL (or a matching domain name) may then be returned to the client system that supplied the URL to comments server 120. The client's comment bar application may then display the received comments in the comments bar application interface. In this manner, comments supplied by other users in association with any web page may be retrieved and displayed by client systems navigating to the web page for which comments have been supplied.

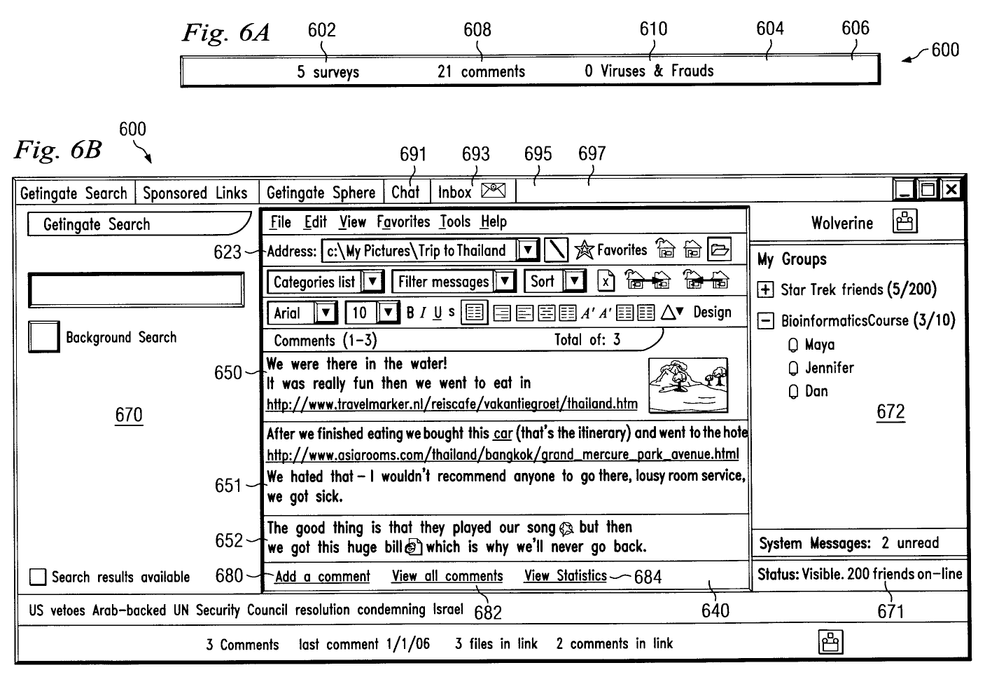

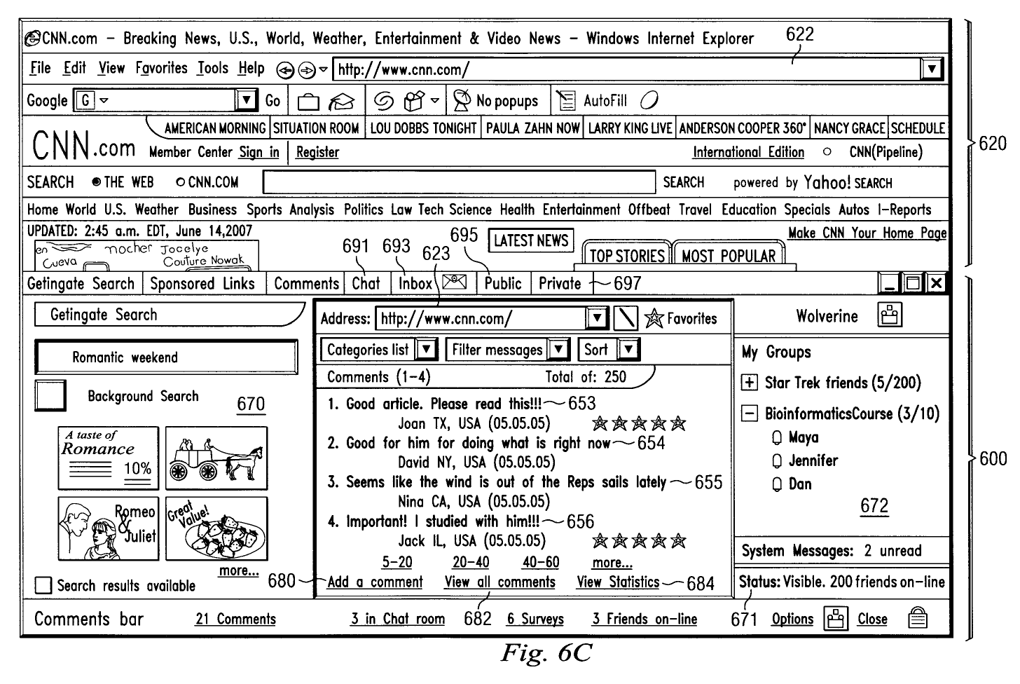

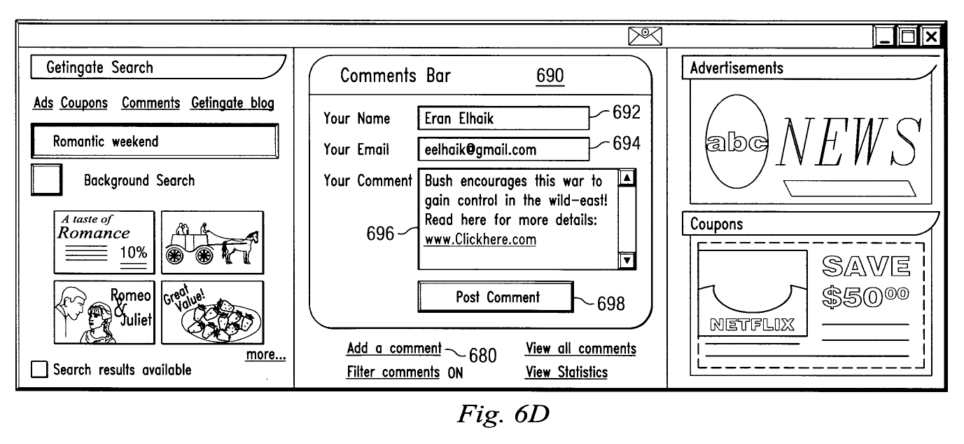

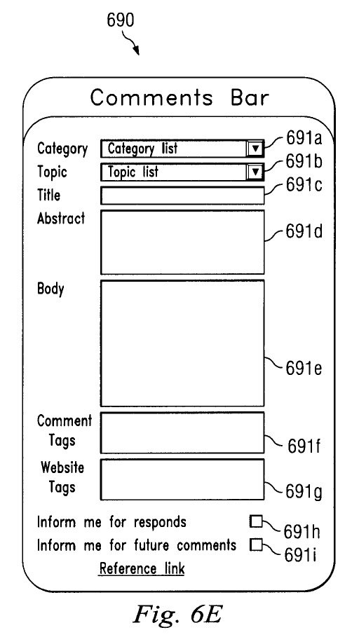

FIG. 6A is a diagrammatic representation of a comments bar 600 application user interface implemented in accordance with an embodiment. In an embodiment, comments bar 600 may be displayed in an expanded configuration or a collapsed configuration. As referred to herein, an expanded configuration is a configuration in which comments of a web page displayed in a browser are displayed within comments bar 600, and a collapsed configuration is a configuration in which comments of a web page displayed in a browser are not displayed within comments bar 600. In the illustrative example, comments bar 600 is displayed in a collapsed configuration. Comments bar 600 may include various controls 602-610 that may be selected by a user. In the illustrative example, a surveys control 602 may be selected that results in display of one or more surveys with which the user may participate. Options control 604 may be selected that navigate the user to an options menu, e.g., configuration options for user selection. Open control 606 may be selected to open comments bar into an expanded view. A comments control 608 may display the number of comments submitted. A virus control 610 may provide an indication of any virus or fraud detected for an associated web page. The virus and frauds alert may, for example, be maintained by a provider or third party association of the comments bar application provider. Other controls may be similarly included in comments bar 600.

FIG. 6B is a diagrammatic representation of comments bar 600 configured in an expanded view in accordance with an embodiment. A web page may be concurrently displayed in a panel of a web browser in conjunction with comments bar 600. Comments bar 600 is configured in an expanded view thereby including display of various comments 650-652 in a comments panel 640 of comments bar 600. Comments 650-652 may be displayed in association with a respective user ID that specifies a user that supplied the associated comment, or alternatively comments 650-652 may be displayed in anonymous fashion without association with a particular user as depicted in FIG. 6B. Additionally, a timestamp may be displayed in association with a respective comment 650-652 that specifies the time at which the comment was supplied. Additionally, the comments bar may display various panels 670-672 that may respectively include supplementary content, such as advertisement content, search services, or other content or application functions.

In an embodiment, comments bar 600 is configured for entry and/or display of comments associated with locally stored files. Comments bar 600 may include an address field 623 that specifies a local file or data structure, such as a folder, selected for display of comments supplied therefor and for which new comments may be supplied by the user and associated therewith. In the present example, address field 623 has a local address of “c:\My Pictures\Trip to Thailand”, and thus comments 650-652 are associated with the local directory specified by the path c:\My Pictures\Trip to Thailand. In a preferred implementation, comments 650-652 are associated with the directory structure specified in address field 623 via the address or path. Thus, in the present example, local repository 414 would include a respective record for each of comments 650-652. Each comment 650-652 was made in association with the file path “c:\My Pictures\Trip to Thailand” as displayed in address field 623, and thus each record for comments 650-652 will include the file path “c:\My Pictures\Trip to Thailand” in an address field of the repository. User IDs of user's that have posted comments 650-652 and timestamps may likewise be recorded in a respective record. The user may navigate to other files or data structures by entry or selection of a file path or directory structure in address field 623.

In operation, when a user selects or enters a data structure or file path in address field 623, the comments bar application interrogates local repository with the supplied file path or data structure. Any records in repository 414 having a matching file path or data structure thereby indicating the comments of the matching records were supplied in association with the currently entered data structure are then returned to the comments bar application where the comments are displayed in comments bar 600. Once the user selects another file structure of path, comments 650-652 are removed from the comments bar display, and the comments bar application may again interrogate local repository 414 with the file path or data structure of the newly specified data structure or file path.

FIG. 6C is a diagrammatic representation of comments bar 600 configured in an expanded view as may be displayed in conjunction with a browser window display of a web page 620 on a display device in accordance with an embodiment. Web page 620 is displayed in a panel of a web browser. The URL of web page 620 may be displayed in an address field 622 of the web browser. Comments bar 600 is configured in an expanded view thereby including display of various comments 653-656 in a comments panel 640 of comments bar 600. Comments 653-656 may be displayed in association with a respective user ID that specifies a user that supplied the associated comment, or alternatively comments 653-656 may be displayed in anonymous fashion without association with a particular user as depicted in FIG. 6C. Additionally, a timestamp may be displayed in association with a respective comment 653-656 that specifies the time at which the comment was supplied. Additionally, the comments bar may display various panels 670-672 that may respectively include supplementary content, such as advertisement content, search services, or other content or application functions.

In an embodiment, each displayed comment 653-656 is associated with web page 620. In a preferred implementation, comments 653-656 are associated with web page 620 via the URL assigned to web page 620. Thus, in the present example, repository 122 would include a respective record in table 500 for each of comments 653-656. Each comment 653-656 was made in association with the web page having the URL “www.cnn.com” as displayed in address field 623 of comments bar 600, and thus each record for comments 653-656 will include the URL “www.cnn.com” in URL field 530a of table 500. User IDs of user's that have posted comments 653-656 and timestamps may likewise be recorded in a respective record.

In operation, a user navigates to the depicted web page by supplying the URL “www.cnn.com” to address field 622, and web page 620 having the supplied URL is displayed in the browser window. The comments bar application interrogates comments server 120 with the supplied URL. Any records in repository 122 having a matching URL thereby indicating the comments of the matching records were supplied in association with the currently displayed web page are then returned to the comments bar application where the comments are displayed in comments bar 600. Once the user navigates away from the currently displayed web page, comments 653-656 are removed from the comments bar display, and the comments bar application may again interrogate comments server 120 with the URL of the newly navigated page.

Additionally, the comments bar application may include, or interface with, other applications or utilities. In the illustrative example, the comments bar application may include a chat control 691 that invokes a chat application integrated or interfaced with the comments bar application. In accordance with an embodiment, the chat application may be URL or domain based. For example, a chat room may be established with each user currently viewing a particular web page added to the chat room. In this manner, user's may discuss content of a web page commonly viewed by the chat room members. Likewise, the comments bar application may include an email control 693 that invokes an email application integrated or interfaced with the comments bar application.

Additionally, the comments bar application may include or interface with a survey system. In this implementation, advertisers may associate surveys with URL addresses, and the surveys may be presented, e.g., in a panel of the GUI, in a manner similar to the mechanism by which comments are presented to a user in a particular URL. Other applications nay also be used, all based on the comments bar application.

In accordance with another embodiment, comments may be submitted as “public” or “private” by selection of a respective public control 695 and a private control 697. Public comments may be viewed by another user having the comments bar application installed at a client visiting a web page for which a public comment has been submitted. Private comments may be viewed only by the user that submitted the private comment. In other implementations, comments may be associated with a particular group of users such that only group members may retrieve a comment from the comments server for viewing thereof.

FIG. 6D is a diagrammatic representation of a comments entry interface 690 that may be displayed within comments bar 600 in accordance with an embodiment. Entry interface 690 may be activated for display in response to selection of an appropriate control, such as control 680, and displayed on comments bar 600. Interface 690 may include fields 692 and 694 for respective entry of the user's name and email address or other personal information. A comment field 696 provides for user-entry of a comment to be submitted in association with a web page displayed by a browser application. Other fields, e.g., for tagging comments, classifying comments, topic association with comments, may similarly be provided by entry interface 690. A post comment control 698 may be selected by the user after entry of a comment in comment field 696. In response to selection of control 698, the comments bar application may read the comment supplied to comment field 696, formulate a comment message including the URL of the page currently displayed by the browser application, and optionally the user ID and timestamp or other supplementary information. The comment message (and all other details, either entered by the user or collected by the system) may then be transmitted to comment server 120 for storage thereby in a record of repository 122.

FIG. 6E is a diagrammatic representation of another embodiment of a comments entry interface 690 of a comments bar implemented in accordance with an embodiment. In the present example, comments entry interface 690 includes various fields 691a-691g and may include one or more controls 691h-691i. A category field 691a may comprises a drop down menu of pre-programmed and/or user supplied categories for selection by the user. For example, the user may select a category that generally describes a subject or comment to be associated with the comment. In other embodiments, category field 691a may comprise a text entry field rather than a drop down menu. In a similar manner, a topic field 691b may comprise a drop down menu of preprogrammed or user specified topics for which the user may select and thereby associate a topic with the comment.

A title field 691c may comprise a text field that allows user supply of a title to be associated with the comment. An abstract field 691d comprises a text field in which a user may write an abstract or comment summary that is associated with the comment. A body field 691e comprises a text field in which the user may supply the comment text. A comments tag field 691f may allow a user to specify one or more tags that are to be associated with the comment. Tags may be provided as public or private in association with the comment.

User selectable controls 691h and 691i may be selected to provide the user notification of any user responses to the comment and for notification of any additional comment postings to the URL or domain for which the user comment is posted, respectively. In the depicted example, the comments bar may be configured with the user ID or user name and/or email address and thus does not require a user ID field or email address field. Alternatively, such fields may be included in the comments entry interface.

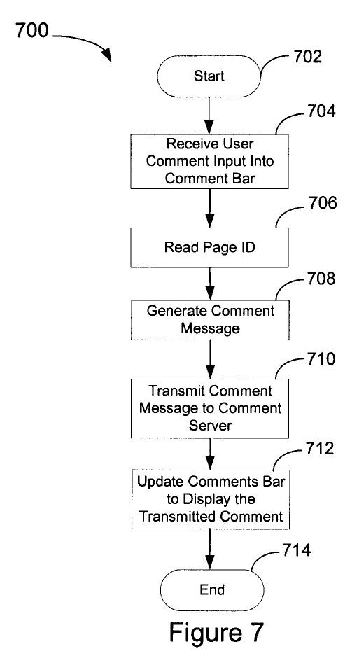

FIG. 7 is a flowchart 700 depicting a client-side comment bar processing routine that may be implemented in accordance with an embodiment. The processing routine is invoked (step 702), and the client comment bar application receives entry of a comment (step 704). On receipt of the user comment, the client comment bar application may read the page URL or other identifier of the page displayed during entry of the comment (step 706). A comment entry message may then be generated (step 708). The comment message may include various fields including a URL field that has the URL of the page for which the comment was entered and a comment field having the comment text or other comment content stored therein. Additionally, the comment message may include a user ID field having a user identifier of the user that has entered the comment. The user ID may comprise a user handle, nickname, or other identifier associated with the user. The comment message may be encapsulated in the payload field of one or more packets addressed to comments server 120.

Upon generation of the comment message, the comment message may be transmitted to comments server 120 (step 710) whereupon the comment text, page URL, and user identifier and timestamp may be parsed therefrom and stored in comment repository 122. Upon transmission of the comment message to comment server 120, the comments bar may be updated to include display of the newly supplied comment (step 712), and the client side comment bar processing routine cycle may end (step 714).

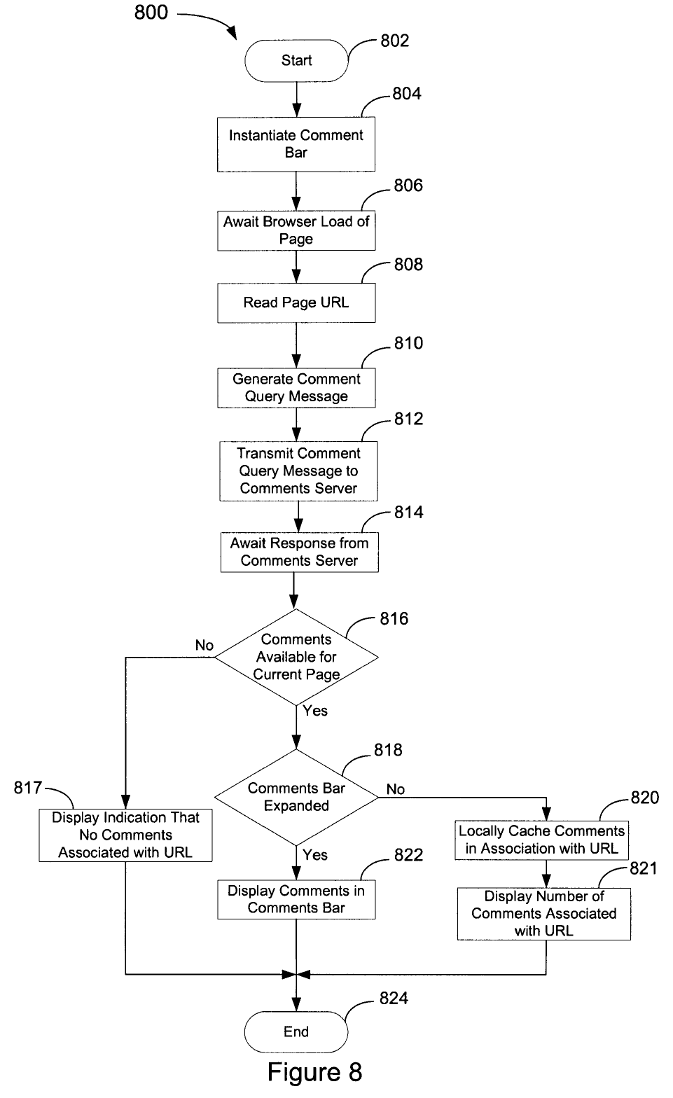

FIG. 8 is a flowchart 800 depicting a client-side comment bar processing routine for displaying user comments made in association with a web page that may be implemented in accordance with an embodiment. The processing routine is invoked (step 802), e.g., upon loading of a client web browser, and a comment bar is instantiated (step 804). The comment bar application may then await loading of a web page in the browser (step 806). Once a web page is loaded in the browser, the comment bar application may read or otherwise acquire the page URL (step 808) or domain, and a comment query message may then be generated (step 810). The comment query message may comprise, for example, a payload field having the URL or domain of the web page currently displayed by the browser. The comment query message may then be transmitted to comment server 120 for interrogation of comment repository 122 (step 812). The client-side comment bar processing routine may then await a response from comment server 120 (step 814). On receipt of a response from comment server 120, the client-side comment bar routine may evaluate the response to determine if any comments have been returned for the current URL or domain (step 816). In the event that no comments were returned for the current URL or domain, the client-side comment bar processing routine may provide an indication that no comments are currently associated with the URL or domain (step 817), and the processing routine cycle may then end (step 824).

Returning again to step 816, in the event that one or more comments were returned to the client from comment server 120 in the query reply, the client-side comment bar processing routine may evaluate whether the comment bar is currently in an expanded configuration (step 818). In the event that the comment bar is not currently expanded, the client-side comment bar processing routine may locally cache, e.g., in local repository 414, the received comment(s) in association with the page URL (step 820). In this manner, the comment(s) may be displayed in response to expansion of the comment bar by the user without a delay required for interrogating the comment server as described more fully hereinbelow. After local caching the received comment(s), the client-side processing routine cycle may provide an indication of the number of comments associated with the current URL or domain (step 821), and the processing routine cycle may then complete according to step 824.

Returning again to step 818, in the event that the comment bar is currently expanded, the client-side processing routine may proceed to display the comment(s) received from comments server 120 in the comment bar (step 822), and the client-side processing routine cycle may end according to step 824.

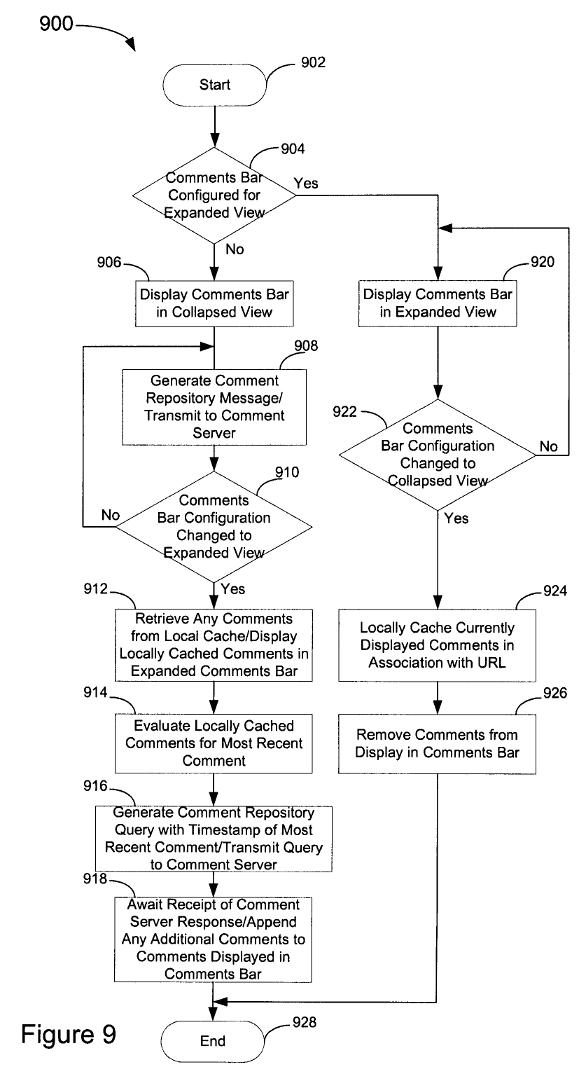

FIG. 9 is a flowchart 900 of a client-side comment application processing routine that facilitates expansion and collapse of a comments bar in accordance with an embodiment. The client-side comment bar application is invoked (step 902), e.g., on instantiation of a browser, and an evaluation may be made to determine whether the comments bar is configured for initial display in an expanded or collapsed view (step 904). In the event that the comments bar is configured for display in the collapsed view, the comments bar may then be displayed in the collapsed view accordingly (step 906). During display of the comments bar in the collapsed view, the user may enter comments into the comments bar in association with displayed web page(s). In the event that a comment is entered into the collapsed comments bar, a comment message including the user-supplied comment, the URL of a currently displayed web page, and optionally a user ID and timestamp may be generated and transmitted to comment server 120 (step 908) for storage of the comment in repository 122. An evaluation may be periodically made to determine if the user has changed the comments bar configuration for display in the expanded view (step 910). In the event that the comments bar remains in the collapsed configuration, the client-side comments bar processing may continue to receive comments from the user and generate and transmit corresponding comment messages to comments server 120 in response to receipt of comments by the user.

In the event that it is determined at step 910 that the comments bar configuration has been changed to the expanded view, display of the comments bar may be changed to the expanded view, and any comments associated with the current web page URL that are locally cached, e.g., in repository 414, may be retrieved therefrom and displayed in the expanded comment bar (step 912). An evaluation of any comments that are locally cached for the current web page may then be made to identify the most recent comment (step 914). A comment repository query may then be generated that includes a timestamp of the most recent comment for the currently displayed web page, and the query may be transmitted to comment server 120 (step 916). The client-side comment bar application may then await receipt of a response from comment server 120 and may append any additional comments to the comments displayed in the comment bar (step 918). The client-side comment bar processing routine cycle may then end (step 928).

Returning again to step 904, in the event that the comment bar is configured for display in the expanded view, the comments bar may be displayed in the expanded view accordingly (step 920). For example, the client-side comments bar application may interrogate comments server 120 for a request for any comments associated with the currently displayed web page and may display any comments received therefrom in the expanded comments bar. An evaluation may periodically be made to determine if the comments bar configuration has been changed to the collapsed view (step 922). In the event that the comments bar remains in the expanded view, the client-side comments bar may continue to display comments for a currently displayed web page in the expanded comments bar according to step 920.

In the event that it is determined that the comments bar configuration has been changed to the collapsed view, the currently displayed comments may be locally cached, e.g., local repository 414, along with the associated URL for the web page with which the comments are associated (step 924), and the comments bar may then be collapsed by removing display of the comments of the current web page (step 926). The client-side comments bar application processing routine cycle may then end according to step 928.

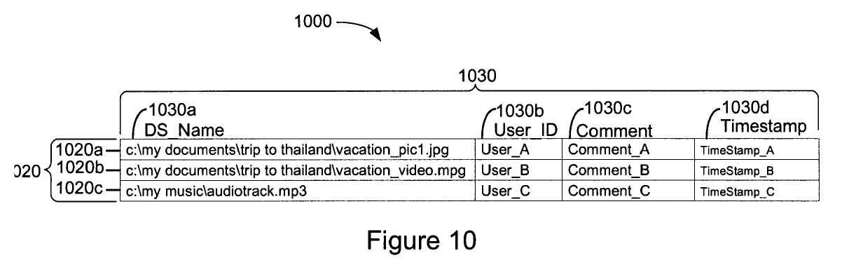

In accordance with another embodiment, local repository 414 may be used to store user-supplied comments that are associated with local files, directories, or other data structures. FIG. 10 is a diagrammatic representation of a table 1000 comprising a plurality of records 1020a-1020c (collectively referred to as records 1020) and fields 1030a-1030d (collectively referred to as fields 530) that may be implemented in local repository 414 for storing user-supplied comments associated with local files, directories, or other data structures in accordance with embodiments disclosed herein. Table 1000 may be stored on a disk drive or other suitable medium, fetched therefrom by a processor or other instruction processing device, and processed by a data processing system such as a client system 108-112 depicted in FIG. 1.

Fields 1030 have a respective label, or identifier, that facilitates insertion, deletion, querying, or other data operations or manipulations of table 1000. In the illustrative example, fields 1030a-1030d have respective labels of DS_Name, User_ID, Comment, and TimeStamp. Each record 1020a-1020c records a user-supplied comment in association with a data structure (DS) name or other identifier of a local data structure for which the associated comment was supplied.

Data elements stored in DS_Name field 1030a may comprise a data structure name, such as a file name, a directory name, or other data structure identifier that specifies a particular locally-stored data structure. In the illustrative example, data elements stored in DS_Name field 1030a of records 1020a-1020c comprise data structure names of “c:\my documents\trip to Thailand\vacationpic1.jpg”, “c:\my documents\trip to Thailand\vacation_video.mpg”, and “c:\my music\audiotrack.mp3”. Thus, in the illustrative example, the data elements of DS_Name field include a file path in addition to a file name or label that specifies a file location. User_ID field 1030b may maintain data elements, such as user names or tags, assigned to a user that may use the client system hosting the comment bar application. In the illustrative example, data elements stored in User_ID field 1030b of respective records 1020a-1020c comprise user IDs of “User_A”, “User_B” and “User_C”. Comment field 1030c may maintain data elements, e.g., string-type data elements, comprising a user-supplied comment provided in association with a local data structure specified by DS_Name field 1030a of a corresponding record 1020. In the illustrative example, comments maintained in Comment field 1030c of respective records 1020a-1020c are illustratively designated “Comment_A”-“Comment_C” and are representative of comment strings supplied by a user in association with a local data structure. It is understood that comments supplied by a user and stored in Comment field 1030c may comprise alphabetic, numeric, alphanumeric, hypertext, video, flash, music files as well as other graphic characters that may be supplied by a user by an input device such as a keyboard and may comprise multiple input lines of data. TimeStamp field 1030d may maintain a timestamp value that indicates the time at which the comment maintained in comment field 1030c of a corresponding record was supplied by the user. Data elements stored in TimeStamp field 1030d of respective records 1020a-1020c are illustratively designated “TimeStamp_A”-“TimeStamp_C” and are representative of a time code specifying a time at which a comment recorded in Comment field 1030c was supplied by a user. The timestamp may specify a day, date, and/or time at which a corresponding comment was supplied by a user.

In operation, comment bar application 412 may be activated in association with file manager 410 or as a separate, independent application and may allow user supply of comments that are associated with a local data structure selected in the file manager or that is specified in the comments bar application. When a user supplies a comment to the client comment bar application, the comment and data structure identifier are stored in table 1000 in local repository 414.

The comments bar application may display a data structure address field that allows a user to select or enter a particular file name. The comments bar may then search table 1000 using the selected file name as an index. Comments of any records found to match the specified data structure may then be displayed in the comment bar application.

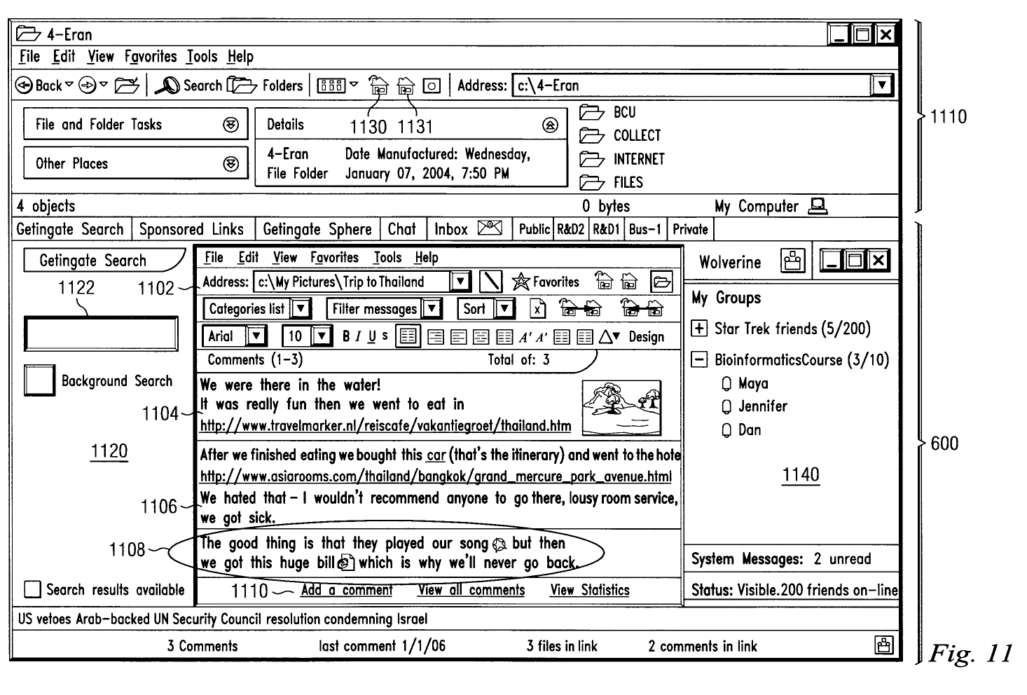

FIG. 11 is a diagrammatic representation of comments bar 600 implemented in accordance with an embodiment that facilitates collection of user-supplied comments related to local data structures, association therewith, and display of the comments. A file manager 1110 may be displayed in association with comments bar 600 and may be adapted to display data structures and organization thereof, e.g., directory structures and configurations thereof. Comments bar 600 may be implemented on any machine or data processing system that stores information in files that are accessible to the user through an application. Comments bar 600 may include a data structure address field 1102 in which a user may select or specify a particular data structure, such as a file or directory. Comments bar 600 may include a control 1110 that, upon user selection, provides an interface for supplying a comment related to a file specified in address field 1102. The comments interface for supplying comments related to local data structures may be implemented in a manner similar to that depicted in FIG. 6D or 6E. Comments supplied by a user may then be associated with the specified data structure by comments bar 600 storing a data structure identifier, e.g., file name, directory name, or the like, in a record of table 1000 with the comment. A user ID and timestamp may optionally be included in the comment record.

When a data structure is specified in address field 1102, comments bar 600 may interrogate table 1000 with the identifier of the specified data structure. In the event that any records have a data structure identifier matching the queried data structure, the associated comment may be retrieved from table 1000 and displayed in comments bar 600. In the illustrative example, three comments 1104-1108 are associated with the file specified in address field 1102 and are displayed in comments bar 600.

Comments bar 600 may include a search panel 1120 that includes a query field 1122 for searching comments stored in table 1000 of the local comments repository. For example, a user may enter a search term in query field 1122, and comments bar 600 may, in turn, search Comment field 1030c with the search term. Any records matching the searched term may be presented to the user thereby allowing the user to select a matching file or directory.

Various controls 1130-1132 may be displayed in comments bar 600 or in association with file manager 1110. In the present example, control 1130 may be selected to connect with a web page, e.g., hosted by comments server 120 that displays all comments supplied by the user. The comments may, for example, be displayed in the web page according to topic, category, date, or other organization. The web page may, for example, be included or interface with a blog adapted to accommodate comment topics and that facilitates further comment discussion or comment receipt by the user. Control 1131 may be selected to connect with a comments center or computer.

Comments bar 600 may include a groups panel 1140 that displays user groups. A user may select a displayed group, or individuals thereof, for example to invoke a chat or other communication session.

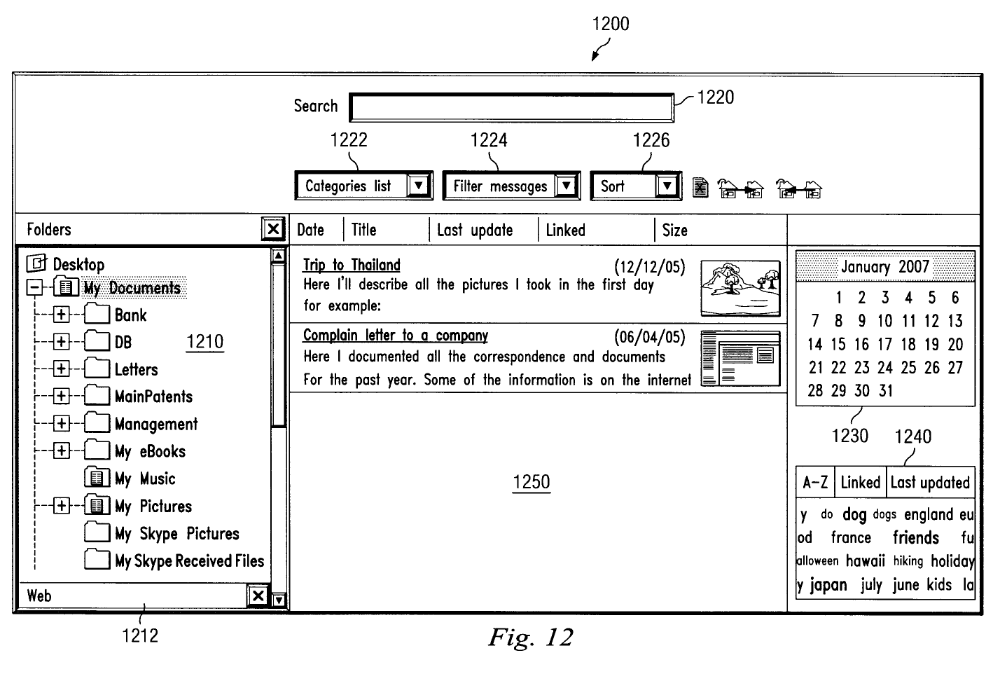

FIG. 12 is a diagrammatic representation of a comments bar interface 1200 that facilitates display and manipulation of comments in accordance with an embodiment. Interface 1200 may include a file manager panel 1210 that displays directories, files, or other local data structures stored on the client system. A user may enter search terms in a search field 1220 for searching for particular comments. For example, comments that match a search term entered in search field 1220 may be displayed in a comments field 1250. The search may be performed on local comments maintained at the client system or may be performed on comments stored at comments server 120, e.g., by selection of a web control 1212.

Various controls 1222-1224 may be included to facilitate searching and display of comments. For example, a categories list control 1222 may comprise a drop down menu of categories that the user may select. Upon selection of a category, the comments (either local or network-stored) may be searched for comments having a matching category. The matching comments may then be displayed in comments panel 1250. Likewise, a filter message control 1224 may comprise a drop down menu of filter items, e.g., dates, keywords, or the like, and messages matching the selected filter item(s) may then be displayed in comments panel 1250. A sort control 1226 may be selected that, for example, sorts comments, e.g., in ascending order based on timestamps or other criteria.

Interface 1200 may include a calendar panel 1230 that allows for selection of a date. Local or network stored comments may then be searched for timestamps having a date matching the date selected in calendar panel 1230. Interface 1200 may include a tags panel 1240 that displays tags of all locally or networks stored comments. Selection of a tag in tags panel 1230 results in searching the local or network-stored comments for comments that having a matching tag. The matching comments may then be displayed in comments panel 1250. Comments that are searched by the various controls of interface 1200 may include comments supplied by the user of the client system that are associated with locally stored files, or comments that have been supplied by the user of the client system in association with URLs or domains. In other embodiments, the search may not be restricted to only comments supplied by the user of the client system, but instead may include comments supplied by other users.

In accordance with another embodiment, comments associated with a local file or URL or domain may be quickly associated with local files or content. For example, a comment displayed in comments panel 1250 may be selected, e.g., by a pointer device, and drag and dropped to a file or data structure, e.g., in file manager panel 1210. The comments bar may then generate an entry in the comments database that associates the selected comment with the selected file or data structure.

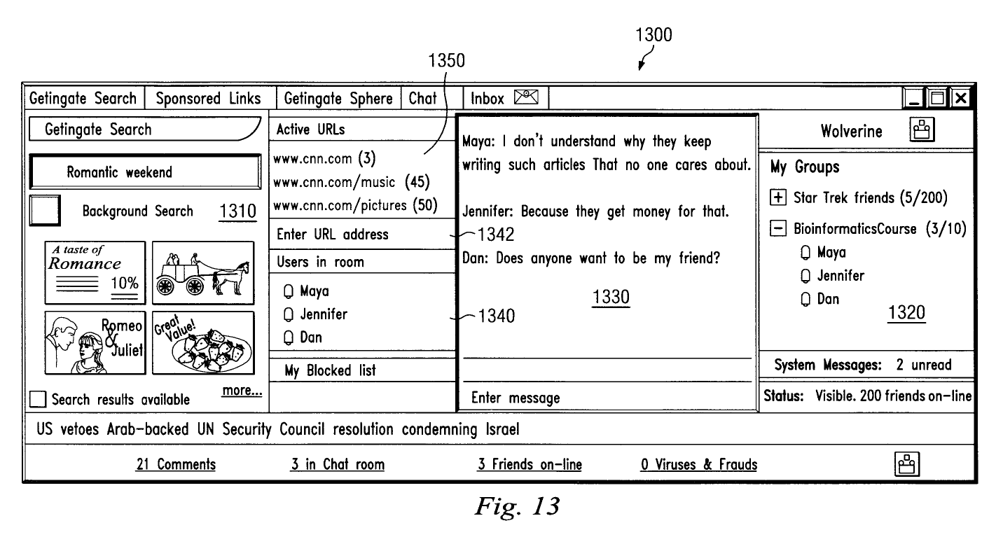

FIG. 13 is a diagrammatic representation of another comments bar interface 1300 that facilitates community interaction among users in accordance with an embodiment. Interface 1300 may include a supplementary panel 1310 that, for example, includes sponsor advertisements, a web search engine, or the like. A chat group panel 1320 may include chat or other social groups and online members thereof, and a chat panel 1330 may include chat messages exchanged among members of an active chat group. An active members panel 1340 may display members of a group that are active in the chat. In accordance with an embodiment, chat groups may be based on a per URL or domain basis. To this end, a URL field 1342 may be included in interface 1300 that allows a user of the comments bar to enter a URL. Members currently active in a chat associated with the URL or domain may then be displayed in the members panel 1340. An active URL panel 1350 may display URLs with which the user of the client system may engage in a chat session with other members. Multiple URLs may be displayed in active URL panel 1350. A user may toggle between URL-based chat sessions by selecting a URL in active URLs panel 1350. In response to selection of a URL in panel 1350, the display of chat panel 1330 may be refreshed to display the chat session associated with the selected URL.

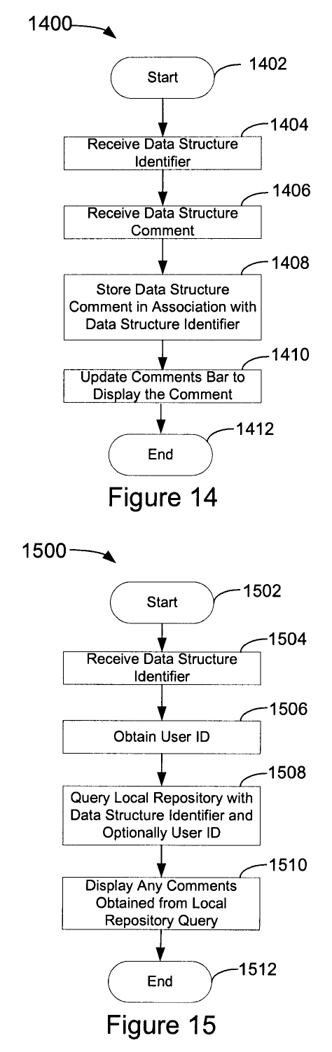

FIG. 14 is a flowchart 1400 depicting client-side processing of a comments bar routine for collecting data structure comments in accordance with an embodiment. The comments bar application is invoked (step 1402), and the comments bar application may receive a data structure identifier (step 1404), e.g., through user supplied input or selection of a particular data structure in address field 1102. The comments bar application may then receive a comment to be associated with the selected data structure (step 1406), e.g., through user supply of descriptive comment text in a comment interface of comments bar 600. The comments bar application may then store the data structure identifier and comment in a record of local repository 414 (step 1408), e.g., as a record of a table similar to table 1000. The comments bar application may optionally include a user ID and/or timestamp in the comment record. The comments bar may then update the display to include the newly received comment (step 1410), and the comments bar processing cycle may then end (step 1410).

FIG. 15 is a flowchart 1500 depicting client-side processing of a comments bar routine for displaying comments associated with data structures in accordance with an embodiment. The comment bar application is invoked (step 1502), and the comments bar application may receive a data structure identifier (step 1504), e.g., through user supplied input or selection of a data structure in address field 1102. The comments bar application may optionally receive a user ID (step 1506) and thereafter query local repository 414 with the data structure identifier and optionally the user ID (step 1508). The comments of any records matching the data structure identifier and optionally the user ID may then be retrieved from local repository 414 and displayed in the comments bar application (step 1510). The comments bar application cycle may then end (step 1512).

As described, embodiments disclosed herein provide mechanisms for collection of user-supplied comments that may be associated with network content, such as web pages, and local content, such as files, directories, or other data structures. Comments associated with network content may be stored in a network repository in association with an identifier of the network content for which the comments were supplied. Other network users that view the content may be provided with the user-supplied comments associated with the content. User-supplied comments associated with local content may be stored in a local repository. Comments associated with local content may be displayed to a user in response to selection of the local content.

The flowcharts of FIGS. 7-9 and 14-15 depict process serialization to facilitate an understanding of disclosed embodiments and are not necessarily indicative of the serialization of the operations being performed. In various embodiments, the processing steps described in FIGS. 7-9 and 14-15 may be performed in varying order, and one or more depicted steps may be performed in parallel with other steps. Additionally, execution of some processing steps of FIGS. 7-9 and 14-15 may be excluded without departing from embodiments disclosed herein. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of embodiments disclosed herein may be implemented in software, hardware, firmware, or a combination thereof. The various elements of the system, either individually or in combination, may be implemented as a computer program product tangibly embodied in a machine-readable storage device for execution by a processing unit. Various steps of embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of disclosed embodiments can be loaded onto a computer. The computer program is not limited to any particular embodiment, and may, for example, be implemented in an operating system, application program, foreground or background process, driver, network stack, or any combination thereof, executing on a single computer processor or multiple computer processors. Additionally, various steps of disclosed embodiments may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of facilitating collection and distribution of a comment related to an information resource, comprising:
receiving a user-supplied comment;
associating the user-supplied comment with a reference of an information resource;
storing the comment in association with the reference; and
displaying the comment in response to specification of the information resource.

2. The method of claim 1, wherein associating the user-supplied comment with the reference further comprises associating the user-supplied comment with a uniform resource locator, wherein the information resource comprises content publicly available at the uniform resource locator.

3. The method of claim 1, wherein associating the user-supplied comment with a reference of an information resource further comprises associating the user-supplied comment with a file name of a locally stored file, wherein the information resource comprises the locally stored file.

4. The method of claim 1, wherein storing the comment in association with the reference comprises storing the comment and the reference in a common record in a database.

5. The method of claim 1, wherein the user-supplied comment comprises a comment supplied by a first user, and wherein displaying the comment in response to specification of the information resource further comprises displaying the comment to a second user in response to the second user supplying the reference in a web browser.

6. The method of claim 1, wherein receiving the user supplied comment is performed on a client system, and wherein storing the comment in association with the reference is performed at a network server system.

7. The method of claim 1, wherein receiving the user supplied comment is performed on a client system, and wherein storing the comment in association with the reference is performed at the client system.

8. A computer-readable medium having computer-executable instructions for execution by a processing system, the computer-executable instructions for collection and distribution of comments related to an information resource, comprising:
instructions that receive a user-supplied comment;
instructions that associate the user-supplied comment with a reference of an information resource;
instructions that store the comment in association with the reference; and
instructions that display the comment in response to specification of the information resource.

9. The computer-readable medium of claim 8, wherein the instructions that associate the user-supplied comment with the reference further comprise instructions that associate the user-supplied comment with a uniform resource locator, wherein the information resource comprises content publicly available at the uniform resource locator.

10. The computer-readable medium of claim 8, wherein the instructions that associate the user-supplied comment with a reference of an information resource further comprise instructions that associate the user-supplied comment with a file name of a locally stored file, wherein the information resource comprises the locally stored file.

11. The computer-readable medium of claim 8, wherein the instructions that store the comment in association with the reference comprise instructions that store the comment and the reference in a common record in a database.

12. The computer-readable medium of claim 8, wherein the user-supplied comment comprises a comment supplied by a first user, and wherein the instructions that display the comment in response to specification of the information resource further comprise instructions that display the comment to a second user in response to the second user supplying the reference in a web browser.

13. The computer-readable medium of claim 8, wherein the instructions that receive the user supplied comment comprise instructions executed by a client system, and wherein the instructions that store the comment in association with the reference comprise instructions executed by a network server system.

14. The computer-readable medium of claim 8, wherein the instructions that receive the user supplied comment comprise instructions executed by a client system, and wherein the instructions that store the comment in association with the reference comprise instructions executed by the client system.

15. A system for collecting and distributing comments related to an information resource, comprising:
a processor adapted to execute computer-executable instructions;
a display device communicatively coupled with the processor; and
an input device adapted to receive user input specifying a comment associated with an information resource displayed on the display device, wherein the comment is stored in association with a reference of the information resource, and wherein the comment is retrieved for display by supply of the reference.

16. The system of claim 15, further comprising a network storage device, wherein the information resource comprise a web page, wherein the reference comprises a uniform resource locator of the web page, and wherein the comment and the uniform resource locator are stored in the network storage device.

17. The system of claim 16, wherein a client system conveys the uniform resource locator to a server coupled with the network storage device, and wherein the server retrieves the comment from the network storage device and transmits the comment to the client system.

18. The system of claim 15, further comprising a storage device communicatively coupled with the processor, wherein the information resource comprises a data structure stored on the storage device, and wherein the reference comprises a data structure name.

19. The system of claim 18, wherein the processor executes a file management system, and wherein selection of the data structure results in retrieval of the comment from the storage device and output of the comment on the display device.

20. The system of claim 15, wherein an indicator that specifies the comment as one of public and private is stored in association with the comment and the reference.
